(19) United States
(12) Patent Application Publication
(10) Pub. No.: US 2014/0257911 A1
(43) Pub. Date: Sep. 11, 2014

(54) METHODS AND APPARATUS TO SCHEDULE REFUELING OF A WORK MACHINE

(71) Applicant: DEERE & COMPANY, Moline, IL (US)

(72) Inventor: Noel Wayne Anderson, Fargo, ND (US)

(73) Assignee: Deere & Company, Moline, IL (US)

(21) Appl. No.: 13/791,121

(22) Filed: Mar. 8, 2013

(51) Int. Cl. G06Q 10/06

(52) U.S. Cl. CPC G06Q 10/06315
USPC 705/7.25

(57) ABSTRACT

Methods and apparatus are disclosed for scheduling refueling of a work machine. An example method disclosed herein includes determining a plurality of potential costs of refueling a work machine at a plurality of locations based at least in part on a location of the work machine, a location of a refueling machine, an energy reserve of the work machine, and an energy consumption rate of the work machine to perform one or more tasks of a mission, the energy consumption rate being based at least in part on one or more task parameters, and selecting a refueling location from the plurality of locations based on the plurality of potential costs.

### TECHNICAL FIELD

This disclosure relates generally to determining energy levels of a machine, and, more particularly, to determining when and where to refuel the machine.

### BACKGROUND

Multipurpose work machines can be used in a number of environments, including agriculture/horticulture, turf/yard/garden, construction, forestry, mining, military, road maintenance, snow removal, etc. Within each of those environments a work machine performs many different tasks and the work areas of the environments may have varying conditions, such as altitude, weather, soil conditions, etc. The tasks being performed and/or conditions of the environment can affect fuel consumption of the work machine.

Oftentimes, the size, maneuverability and/or government regulations prevent the work machines from using government roads or highways to move from one work area to a storage location, refueling location, or another work area without making special arrangements. Accordingly, the work machines are commonly stored or primarily kept on-site at the work area until all tasks are completed. In such examples, refueling machines can be brought to the work machines at the work areas for refueling.

### SUMMARY

An example method disclosed herein includes determining a plurality of potential costs of refueling a work machine at a plurality of locations based at least in part on a location of the work machine, a location of a refueling machine, an energy reserve of the work machine, and an energy consumption rate of the work machine to perform one or more tasks of a mission, the energy consumption rate being based at least in part on one or more task parameters, and selecting a refueling location from the plurality of locations based on the plurality of potential costs.

An example apparatus disclosed herein includes a cost estimator to determine a plurality of potential costs of refueling a work machine at a plurality of locations based at least in part on a location of the work machine, a location of a refueling machine, an energy reserve of the work machine, and an energy consumption rate of the work machine, the energy consumption rate being based at least in part on one or more task parameters, and a location selector to select a refueling location from the plurality of refueling location based on the plurality of potential costs.

An example tangible computer readable storage medium is disclosed herein having machine readable instructions that when executed cause a machine to perform a method to determine a plurality of potential costs of refueling a work machine at a plurality of locations based at least in part on a location of the work machine, a location of a refueling machine, an energy reserve of the work machine, and an energy consumption rate of the work machine to perform one or more tasks of a mission, the energy consumption rate being based at least in part on one or more task parameters, and select a refueling location from the plurality of locations based on the plurality of potential costs.

### BRIEF DESCRIPTION OF THE DRAWINGS

FIG. 1 illustrates a first example environment of use including a work machine and a refueling machine for use with an example refueling planner disclosed herein.

FIG. 2 is a block diagram of an example refueling planner that may be used to determine a time and/or location for a work machine to be refueled by a refueling machine in a work environment.

FIG. 3 is a flowchart of an example method for determining a time and/or location for a work machine to be refueled by a refueling machine in a work environment.

FIG. 4 is a flowchart of an example method for estimating costs of refueling a work machine at potential refueling locations.

FIG. 5 illustrates a second example environment of use for the refueling planner of FIG. 2.

FIG. 6 is a graph representing cost estimates for the refueling planner of FIGS. 1 and/or 2 for refueling a work machine over a period of time based on an average amount of fuel added per refuel.

FIG. 7 is a block diagram of an example processor platform to execute the methods of FIGS. 3 and/or 4 to implement the example refueling planner of FIG. 2.

### DETAILED DESCRIPTION

Methods and apparatus for planning a path for a machine to traverse a work area are disclosed herein. Example methods include estimating a plurality of potential costs of refueling the work machine at a set of locations, selecting a cost from the plurality of costs, and identifying the corresponding time and/or corresponding location to refuel the work machine.

In the example methods, an example refueling planner determines potential locations to refuel a work machine. The refueling planner estimates an energy consumption rate of the work machine and estimates where refueling may be performed or where refueling may be necessary. The refueling planner makes the estimations based on a mission type, such as clearing a forest or harvesting a field. Additionally or alternatively, the refueling planner makes the estimations based on tasks to be performed during the mission, such as trimming a tree, felling a tree, tilling the work area, plowing the field, harvesting crops, etc. Furthermore, in some examples, the refueling planner alternatively or additionally makes the estimations based on task parameters associated with the mission tasks, such as topographic inclines/declines, soil conditions, vegetation conditions, vegetation height, vegetation density, type of trees/crops being cleared/harvested, crop yield, equipment in use, expected load, etc. The example refueling planner may be partially or entirely located onboard the work machine and/or may be partially or entirely located at a central facility or onboard another vehicle associated with the work machine, such as a refueling machine, another work machine, etc. The refueling planner may be implemented by a mobile device, such as a cellular phone, a smartphone, a personal digital assistant (PDA), a tablet computer, etc.

The refueling planner includes an example cost estimator to determine potential costs for a set of locations. For example, the cost estimator may retrieve geographic coordinates corresponding to the set of locations stored in a data storage device associated with the refueling planner. In some examples, a work path may be planned for the work machine, and the user can request cost estimates of refueling the work machine at various locations of the work path such as at specific locations of the work paths, at different intervals of the work paths, etc. The example cost estimator may determine the costs based on an energy reserve, an energy consumption rate, a location of the work machine, and/or a location of a refueling machine. In some examples, the cost estimator can estimate monetary costs, time costs, man-hour costs, or any other similar costs of refueling.

The example cost estimator may also take into account expected downtime costs for potential refueling locations. The example downtime costs take into account the probability that the work machine runs out of fuel based on the time required for a refueling machine to meet at the corresponding location.

In some examples, a number of locations are presented to a user via a display of a user interface. For example, a table of potential locations may be displayed to the user based on a planned work path for the work machine. The example table may also include corresponding estimated times of arrival and/or corresponding projected fuel remaining in the work machine for the potential locations. An example planned work path may be determined by a path planning system and/or input via a user interface of the refueling planner. In some examples, a map is presented to the user indicating the locations with corresponding times that the work machine is expected to be at that location.

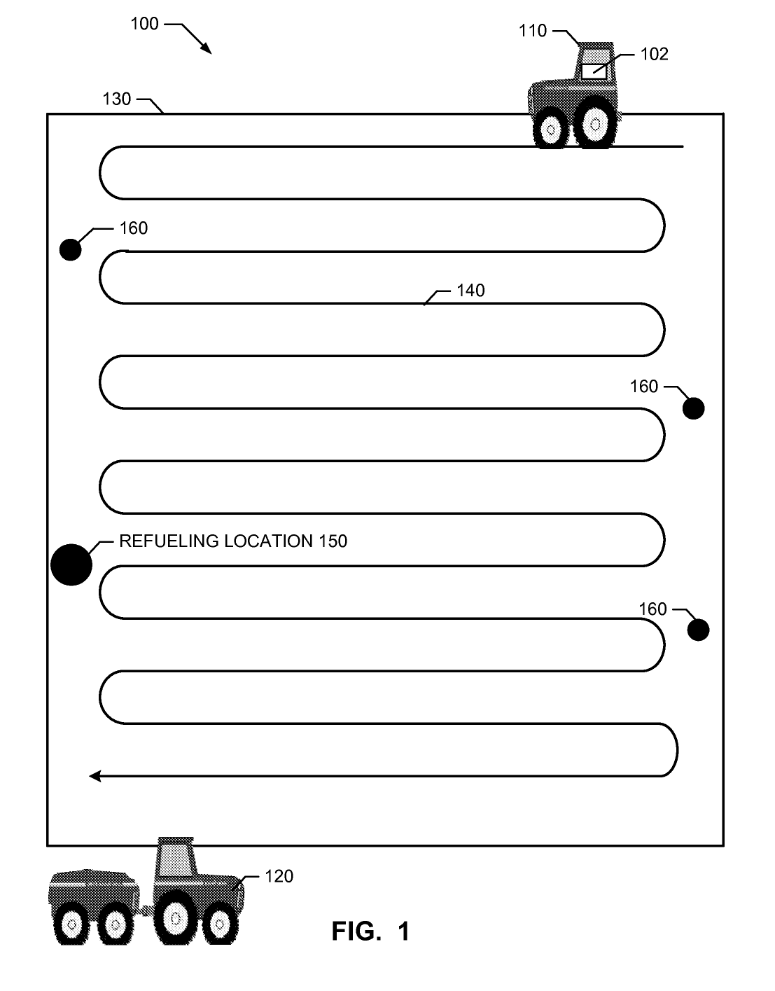

FIG. 1 illustrates an example environment of use 100 including a work machine 110 and a refueling machine 120 for use with an example refueling planner 102. In FIG. 1, the example refueling planner 102 may be used by the work machine 110 and/or the refueling machine 120. In the illustrated example of FIG. 1, the refueling planner 102 is located onboard the work machine 110, though the refueling planner 102 may be located onboard the refueling machine 120, at a central facility, or on another vehicle associated with the work machine 110 and/or refueling machine 120. In some examples, the refueling planner 102 may be implemented by a mobile device, for example, a smartphone, personal digital assistant, tablet computer, etc.

The example environment 100 includes a work area 130 used for one or more of agriculture, horticulture, turf/yard/garden, construction, forestry, mining, military, road maintenance, etc. For example, the work area 130 may be a forest that is to be logged, a field that is to be harvested, a yard that is to be mowed, a parking lot that is to be snowplowed, etc. In the illustrated example of FIG. 1, the work machine 110 has a work path 140 that it is scheduled to follow to complete a given task. The work path 140 may be input by a user or generated automatically (see U.S. patent application Ser. No. ______ (Attorney Docket No. 2024I/P20988)).

In the example of FIG. 1, the refueling planner 102 is used to determine a refueling location 150 along the work path 140. The refueling planner 102 determines the refueling location 150 based at least in part on cost estimations of the refueling location 150 and potential refueling locations 160. For example, the refueling planner 102 of FIG. 1 may have determined that the refueling location 150 is preferred over the potential refueling location 160 by comparing the cost estimations of the locations 150 and 160. The example refueling planner may select the refueling location 150 based on one or more types of costs such as monetary costs, time delay, man-hours, desired amount of fuel remaining after mission, etc. As an example, the corresponding cost estimations for the refueling location 150 and potential refueling locations 160 are based on one or more of a number of factors including a location of the work machine 110, a location of the refueling machine 120, an energy reserve of the work machine 110, and/or an energy consumption rate to perform a task in the work area 130. The energy reserve may be estimated based on fuel type in use by the work machine and volume of remaining fuel in the work machine 110. The energy consumption rate may be estimated based on one or more of mission type, tasks to be performed, and/or various features of the work area 130, or machine characteristics of the work machine 110.

After the refueling planner 102 selects the refueling location 150, the work machine 110 and refueling machine 120 may meet at the refueling location 150 at a corresponding time calculated during the cost estimation. For example, a user may have selected the geographic coordinates of the refueling location 150 and potential refueling locations 160. The refueling planner may then estimate times that the work machine 110 and/or the refueling machine 120 is expected to arrive at the corresponding locations 150, 160 and the corresponding costs of refueling at those times. In some examples, the refueling planner 102 provides information, such as coordinates or directions, corresponding to the refueling location to the work machine 110 and/or the refueling machine 120.

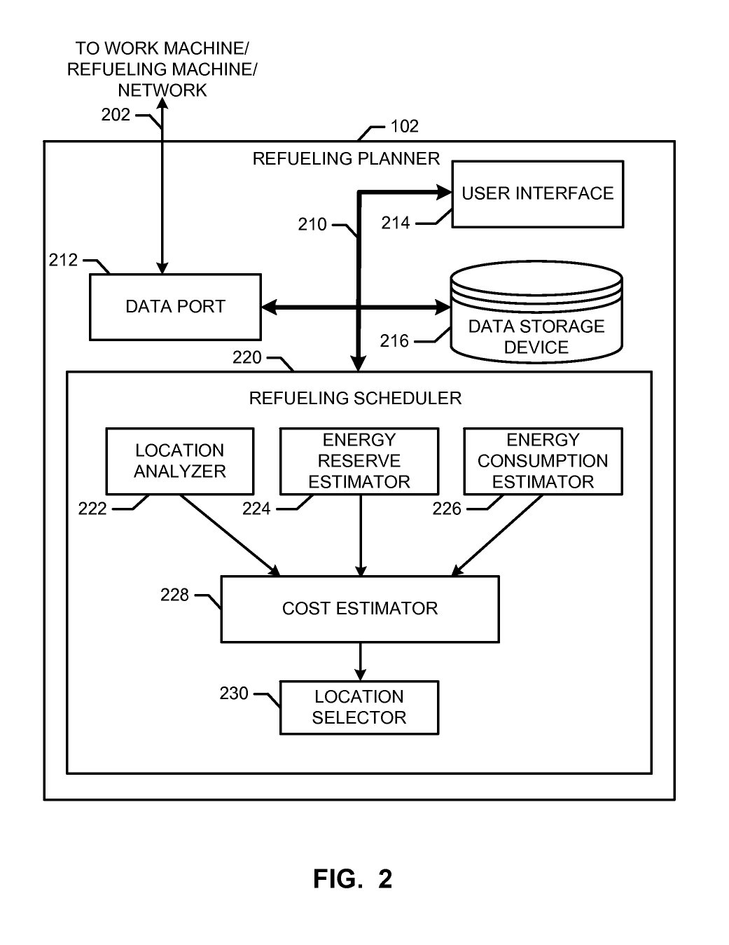

FIG. 2 is a block diagram of an example refueling planner 102 that may be used to determine a time and/or location for the work machine 110 to be refueled by the refueling machine 120 of FIG. 1. Thus, FIG. 2 illustrates a detailed view of an example implementation of the refueling planner 102 of FIG. 1.

The refueling planner 102 of FIG. 2 communicates with the work machine 110, the refueling machine 120, and/or a network via a communication link 202. The communication link 202 may be one or more of a wireless connection, such as Wi-Fi, Bluetooth™, cellular, etc. or a wired connection such as a serial line, parallel line, universal serial bus (USB), etc. The communication link 202 may include a wireless communication link with a network that facilitates communication between the work machine 110, the refueling machine 120, and the refueling planner 102. In some examples, the refueling planner 102, partially or entirely, is located onboard the work machine 110 and/or the refueling machine 120. Additionally or alternatively, the refueling planner 102 may be located on a server at a central facility in communication with a network, such as a local area network (LAN), a wireless area network (WAN), cellular network, the Internet, etc. In such examples, the network enables communication between the refueling planner 102 and the work machine 110, the refueling machine 120, and/or devices associated with the work machine 110 and refueling machine 120.

In FIG. 2, the refueling planner 102 includes a communication bus 210 to facilitate communication between a data port 212, a user interface 214, a data storage device 216, and a refueling scheduler 220. The data port 212 facilitates communication between the refueling planner 102 and the work machine 110 and/or the refueling machine 120 via communication link 202.

The user interface 214 includes input devices such as a keyboard, a mouse, a touchscreen, etc. and/or output devices such as a display, one or more speaker(s), etc. to enable communication between a user and the refueling planner 102. The data storage device 216 of FIG. 2 may be used to store location information or data associated with the work machine 110 and/or refueling machine 120. The example data associated with the work machine 110 and/or refueling machine 120 may include one or more of heuristics, fuel consumption statistics, machine performance characteristics, machine health information, or other similar information. In some examples, viewing and refuel scheduling settings may be distributed across a number of people including the machine operator, a machine owner, an operator supervisor, a logistics manager, an equipment manager, or a project manager. Accordingly, in such examples, profile settings may be created, adjusted, and/or modified using the user interface 214 and stored in the data storage device 216. The example profile samples may limit one or more users' abilities to use the refueling planner 102 based on corresponding user credentials. For example, a machine operator may have a limited ability to view information and/or limited options to make selections for refueling in comparison to an owner or a manager of the work machine 110.

In FIG. 2, the work machine 110 and/or the refueling machine 120 provide(s) the refueling planner 102 with data read from sensors, location information received from global positioning system (GPS) receivers or other navigation devices, and/or other information associated with the work machine 110 and refueling machine 120, respectively. The above information is received by the data port 212 of the refueling planner 102 via the communication link 202. Devices associated with the work machine 110 and refueling machine 120 may additionally or alternatively provide the data and geographic information to the refueling planner 102. Geo-referenced data created by the refueling planner 102 or received from a GPS receiver may take the form of a map and be displayed to the user via the user interface 214.

In FIG. 2, the refueling scheduler 220 schedules potential refueling times and/or locations for refueling the work machine 110 with the refueling machine 120. The refueling scheduler 220 selects a refueling time and location based on a cost estimation of the sets of times and/or locations. For example, a user may provide the set of times or set of locations to the refueling scheduler 220 via the user interface 114. The refueling scheduler 220 may automatically generate the scheduled times and locations or provide a particular time or location based on default or user settings. The refueling scheduler 220 may automatically generate the refueling times and locations once a fuel energy level falls below a threshold value and provide the refueling times and locations to the user and/or an operator of the work machine 110 and/or refueling machine 120 via the user interface 214.

In one example, the refueling scheduler 220 includes a location analyzer 222, an energy reserve estimator 224, an energy consumption estimator 226, a cost estimator 228, and a location selector 230. The cost estimator 228 receives location data from the location analyzer 222, energy data from the energy reserve estimator 224, and energy consumption data from the energy consumption estimator 226. The cost estimator 228 provides cost estimation data to the location selector 230 based on the received data. In an example, the location selector 230 selects a cost for refueling from the cost estimations and provides the selected costs and corresponding location and time information to the user display 214. The cost estimator 228 may provide a list of cost estimations for times and/or locations of refueling to the user interface 214, and the user may select a preferred time and/or location based on the cost estimations.

The location analyzer 222 of FIG. 2 processes received information for the work machine 110 and/or refueling machine 120. In some examples, the location analyzer 222 receives the location information from GPS receivers of the work machine 110 and/or the refueling machine 120. The location analyzer 222 may receive the location information from a user via the user interface 214 or may retrieve “last known” geographic location information for the work machine 110 and/or the refueling machine 120 that was stored in the data storage device 216. The location analyzer 222 provides potential refueling location information to the cost estimator 228.

The energy reserve estimator 224 of FIG. 2 determines the remaining energy for the work machine 110. The energy reserve estimator 224 may receive fuel level information and fuel type and/or vehicle type information from the work machine 110. The energy reserve estimator 224 may determine the remaining amount of energy that the work machine 110 has based on a fuel factor. The energy reserve estimator 224 provides estimated energy reserve information to the cost estimator 228.

The energy consumption estimator 226 estimates an energy consumption rate of the work machine 110. The energy consumption estimator 226 may receive mission and task information from a user via the user interface 214 and/or from the work machine 110. The energy consumption estimator 226 may determine the estimated consumption rate based on data stored in the data storage device 216 for the corresponding mission and/or tasks. Additionally or alternatively, the energy consumption estimator 226 may adjust or further estimate the consumption rate based on other factors including task parameters such as machine characteristics, characteristics of a work area of the work machine 110, etc. received from the work machine or a network in communication with the refueling planner 102. The energy consumption estimator provides energy consumption information to the cost estimator 228.

The cost estimator 228 of FIG. 2 receives the location information, the energy reserve information, and the energy consumption rate information from the location analyzer 222, the energy reserve estimator 224, and the energy consumption estimator 226, respectively. The cost estimator 228 uses the received information to determine an estimated cost for potential refueling locations and/or times. In an example, the estimated costs are based on a sum of a fixed fueling cost, a variable fueling cost, and downtime costs corresponding to the refueling locations and/or times determined by the location analyzer 222.

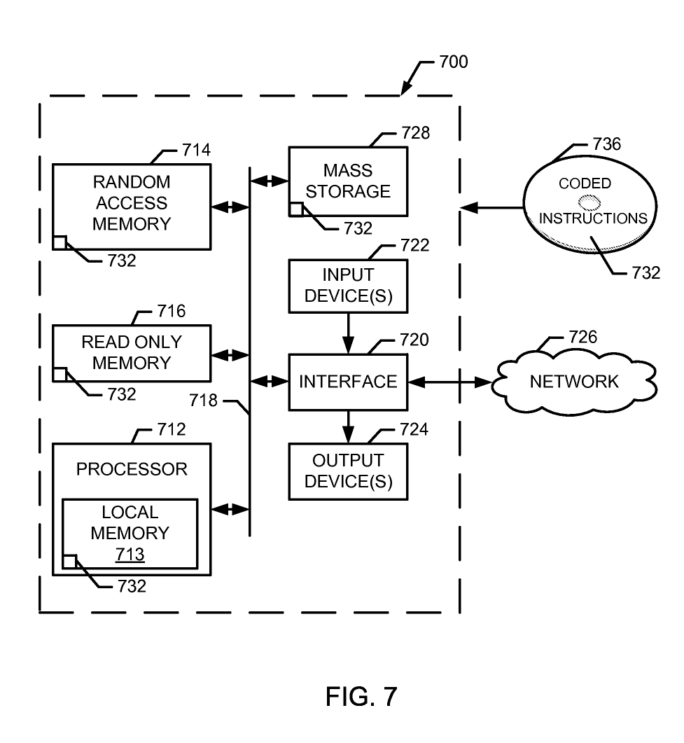

In some examples, the cost estimator 228 of FIG. 2 provides, via a display of the user interface 214, the costs of the set of refueling locations and corresponding times to the user (see FIGS. 7 and 8). In such examples, the user is able to see the locations, times, and/or estimated costs based on the fixed, variable and/or downtime costs, of refueling the work machine 110 to make a decision on where and/or when to refuel the work machine 110 with the refueling machine 120. The user may then select a preferred location for refueling.

In FIG. 2, the location selector 230 is used to automatically select the refueling location based on the costs generated by the cost estimator 228. The location selector 230 may select the location based on a preferred cost type setting including selection of monetary costs of refueling, time for refueling, man-hours/labor costs required to refuel, time delay, or other similar possible costs.

In the illustrated example of FIG. 2, the location selector 230 provides the selected refueling time, location, and/or estimated cost to the user via a display of the user interface 214. The user interface 214 may display the route to the refueling location, such as the work path 140 to refueling location 150, as well as other potential refueling locations, such as the refueling locations 160, on a map. The example map may be one or more of a navigational display, topographical display, etc. The refueling scheduler 220 may also calculate a countdown of an amount of time and/or remaining distance from the refueling location once the location is determined by the location selector 230 or the user. The estimated time and location information from the location analyzer 222, the energy reserve from the energy reserve estimator 224, the consumption rate from the energy consumption estimator 226 may be displayed on the display of the user interface 214. The user of the work machine 110 and/or the operator of the refueling machine 120 may be alerted that the selected time for refueling at the selected location is within a threshold period of time.

While an example manner of implementing the refueling planner 102 of FIG. 1 has been illustrated in FIG. 2, one or more of the elements, processes and/or devices illustrated in FIG. 2 may be combined, divided, re-arranged, omitted, eliminated and/or implemented in any other way. Further, the data port 212, the user interface 214, the data storage device 216, the refueling scheduler 220, the location analyzer 222, the energy reserve estimator 224, the energy consumption estimator 226, the cost estimator 228, the location selector 230, and/or, more generally, the refueling planner 102 of FIG. 2 may be implemented by hardware, software, firmware and/or any combination of hardware, software and/or firmware. Thus, for example, any of the data port 212, the user interface 214, the data storage device 216, the refueling scheduler 220, the location analyzer 222, the energy reserve estimator 224, the energy consumption estimator 226, the cost estimator 228, the location selector 230, and/or, more generally, the refueling planner 102 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the apparatus or system claims of this patent are read to cover a purely software and/or firmware implementation, at least one of the data port 212, the user interface 214, the data storage device 216, the refueling scheduler 220, the location analyzer 222, the energy reserve estimator 224, the energy consumption estimator 226, the cost estimator 228, the location selector 230 are hereby expressly defined to include a tangible computer readable storage medium such as a memory, a digital versatile disk (DVD), CD-ROM, Blu-ray, etc. storing the software and/or firmware. Further still, the refueling planner 102 of FIG. 2 may include one or more elements, processes and/or devices in addition to, or instead of, those illustrated in FIG. 2, and/or may include more than one of any or all of the illustrated elements, processes and devices.

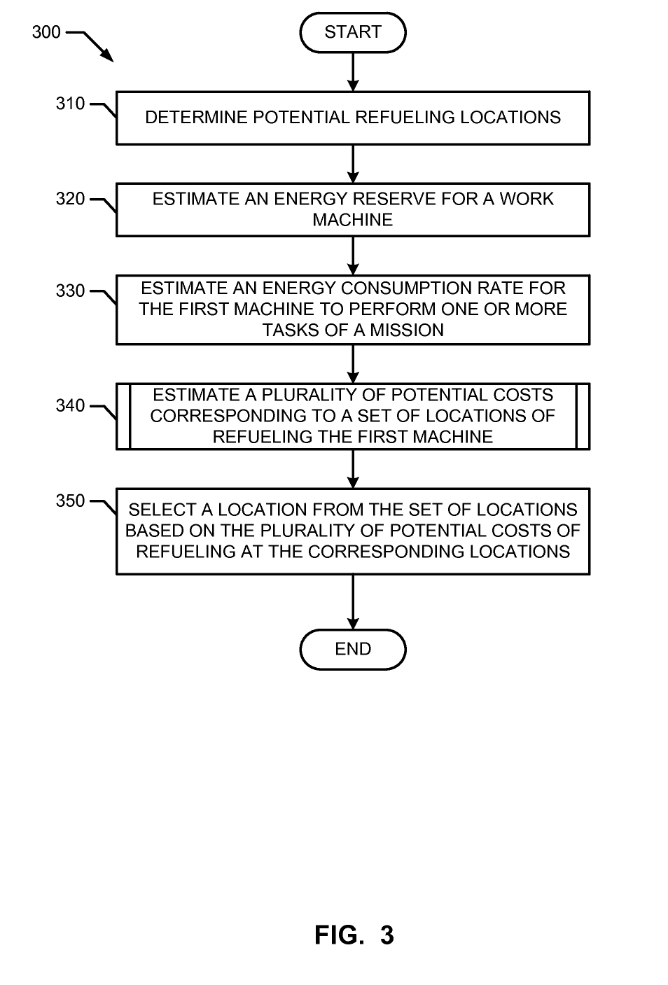

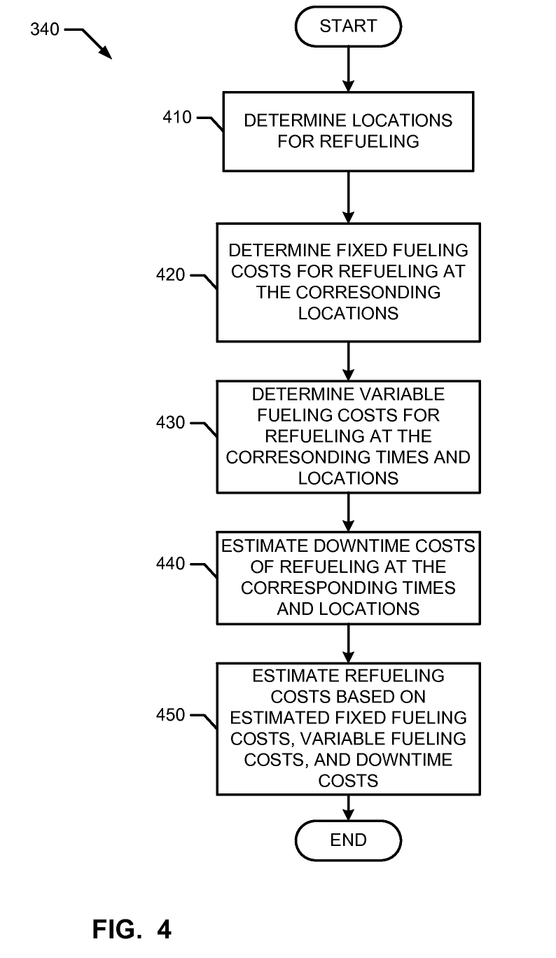

Flowcharts representative of processes that may be implemented using example machine readable instructions stored on a tangible medium for implementing the data port 212, the user interface 214, the data storage device 216, the refueling scheduler 220, the location analyzer 222, the energy reserve estimator 224, the energy consumption estimator 226, the cost estimator 228, the location selector 230, and/or, more generally, the refueling planner 102 of FIG. 2 are shown in FIGS. 3 and 4. In this example, the process may be carried out using machine readable instructions, such as a program for execution by a processor such as the processor 712 shown in the example processor platform 700 discussed below in connection with FIG. 7. The program may be embodied in software stored on a tangible computer readable storage medium such as a CD-ROM, a floppy disk, a hard drive, a DVD, a Blu-ray disk, or a memory associated with the processor 712, but the entire program and/or parts thereof could alternatively be executed by a device other than the processor 712 and/or embodied in firmware or hardware. Further, although the example program is described with reference to the flowcharts illustrated in FIGS. 3 and 4, many other methods of implementing the data port 212, the user interface 214, the data storage device 216, the refueling scheduler 220, the location analyzer 222, the energy reserve estimator 224, the energy consumption estimator 226, the cost estimator 228, the location selector 230, and/or, more generally, the refueling planner 102 may alternatively be used. For example, the order of execution of the blocks may be changed, and/or some of the blocks described may be changed, eliminated, or combined.

The example processes of FIGS. 3 and 4 may be implemented using coded instructions, such as computer readable instructions, stored on a computer readable storage medium. This storage may be a tangible computer readable storage medium in which information is stored for any duration, such as for extended time periods, permanently, brief instances, for temporarily buffering, and/or for caching of the information. In an example, the term tangible computer readable storage medium is defined to include any type of computer readable storage disk or storage device and to exclude propagating signals. Additionally or alternatively, the example processes of FIGS. 3 and 4 may be implemented using coded instructions, such as computer readable instructions stored on a non-transitory computer readable storage medium such as a hard disk drive, a flash memory, a read-only memory, a compact disk, a digital versatile disk, a cache, a random-access memory and/or any other storage media in which information is stored for any duration, such as for extended time periods, permanently, brief instances, for temporarily buffering, and/or for caching of the information. In an example, the term non-transitory computer readable storage medium is defined to include any type of computer readable storage disk or storage device and to exclude propagating signals. As used herein, when the phrase “at least” is used as the transition term in a preamble of a claim, it is open-ended in the same manner as the term “comprising” is open ended. Thus, a claim using “at least” as the transition term in its preamble may include elements in addition to those expressly recited in the claim.

FIG. 3 is a flowchart of an example method 300 for determining a time and/or location for the work machine 110 to be refueled by the refueling machine 120. The example method 300 may be executed to implement the refueling planner 102 of FIG. 2. With reference to the preceding figures and associated descriptions, the process 300 of FIG. 3, upon execution, causes the refueling planner 102 to begin planning refueling for the work machine 110.

At block 310, the location analyzer 222 determines potential refueling locations for the work machine 110. In the example of FIG. 3, the location analyzer 222 may receive the refueling locations from a user via the user interface 214 to determine refueling locations. In some examples, the location analyzer 222 may automatically determine refueling locations for a work area, such as by identifying potential refueling locations stored in the data storage device 216. In some examples, the potential refueling locations are automatically determined based on information received via the data port 212 from a sensor of the work machine 110 or refueling machine 120.

In some examples, at block 310 of FIG. 3, the location analyzer 222 of FIG. 2 determines the distance from the work machine 110 and the refueling machine 120 to a set of refueling locations. The location analyzer 222 may estimate a time of arrival at the designated locations for the work machine 110 based on an estimated operating rate of the work machine 110 and the distance to reach that location. The operating rate may be based on task parameters for tasks that are to be performed along a work path between the current location of the work machine 110 and the designated refueling locations. The distance traveled may be based on a planned work path, such as the work path 140, that the work machine 110 is scheduled travel.

In some examples, the location analyzer 222 determines an expected refueling location based on a received time from a user or operator to refuel. For example, a user may want to know corresponding refueling locations located near an expected location of where the work machine 110 may be one hour, two hours, and/or three hours in the future. Based on the operating rate of the work machine 110 corresponding to the tasks being performed, the location analyzer 222 may identify the nearest refueling locations that may be reached by the refueling machine 120 at those points in time.

Depending on the industry of use for the work machine 110, specific fueling locations may need to be located at predetermined locations or outside of restricted locations of the work area. The predetermined locations or restricted locations may be stored in the data storage device 216. For example, a work machine 110 used in agriculture may not be able to refuel over planted crops for safety purposes so as not to contaminate the crops. Thus the work machine 110 cannot be refueled in the planted field, for example along the work path 140, but may be refueled at locations around the planted field, such as the locations 150, 160. As another example, the refueling machine 120 may not be able to traverse certain areas of the work area that the work machine 110 can traverse due to being a road vehicle, and therefore refueling locations are to be on or near access roads of the work area. For example, in the forestry industry, a refueling machine 120 cannot reach the work machine unless a road is built through the forest. Accordingly, at block 310, the location analyzer 222 may analyze a work area layout to determine potential locations for refueling based on the location of the work machine 110 and accessible areas that can be reached by the refueling machine 120 from its current or possible location.

At block 320 of FIG. 3, the energy reserve estimator 224 estimates an energy reserve for the work machine 110. In an example, the energy reserve estimator 224 receives the fuel level of the fuel tank 110 of the work machine 110 from the work machine 110 and/or a device such as a sensor or a user controlled mobile device associated with the work machine 110. The energy reserve estimator 224 may also determine the type of fuel such as gasoline, #1 diesel, #2 diesel, B2 diesel, B20 diesel, etc. in the fuel tank of the work machine 110. Based on the fuel type and level of fuel remaining in the fuel tank, the energy reserve estimator 224 can calculate an energy reserve of the fuel tank. In the example, the energy reserve is calculated by multiplying the fuel level by a fuel factor associated with the fuel type.

The energy reserve estimator 224 may determine the fuel factor of the fuel in the tank using a number of methods. The fuel factor may be calculated by the reserve estimator 224 using one or more devices on the work machine 110 and/or refueling machine 120 to measure the percentage of constituents in the fuel, such as ethanol in gasoline, biodiesel in diesel, etc. The fuel factor may be calculated by the energy reserve estimator 224 from information received from an engine control system or monitoring system of the work machine 110 that estimates an amount of expected power for a given combustion cycle and calculates the output power to determine the fuel factor. The fuel factor may be estimated based on refueling information that is entered by a user via the user interface 214 and stored in the data storage device 216. For example, the user may identify an amount of fuel added during refueling, a composition of the fuel added, etc. In some examples, at block 320, heuristics may be used to calculate the fuel factor, and the energy reserve estimator 224 may consult historical records of refueling kept in the data storage device 216 to determine the fuel factor. The energy reserve estimator 224 then calculates an estimate of the remaining energy output of the work machine 110 using the fuel level and fuel factor.

At block 330 of FIG. 3, the energy consumption estimator 226 estimates an energy consumption rate for the work machine 110. The energy consumption estimator 226 receives task and mission information from the user via the user interface 214 and/or from devices monitoring the status or operation of the work machine 110. The energy consumption estimator 226, at block 330, may adjust or further estimate the consumption rate based on other factors including task parameters such as machine characteristics, characteristics of a work area of the work machine 110, etc. Sensors on the work machine 110 and/or located at the work area or other location may identify the machine characteristics which may include, but are not limited to, a load of the work machine 110, component health characteristics of the work machine 110, etc. Some example sensors may include fuel gauges, load sensors, speedometers, tachometers, odometers, etc. Some example characteristics of a work area of the work machine 110 include, but are not limited to topography, soil conditions, vegetation conditions, vegetation height, vegetation density, type of trees/crops being cleared/harvested, crop yield, equipment in use, expected load, sensor information, etc. The example machine characteristics and/or characteristics of the work area may be stored on the data storage device 216 and/or retrieved from a central facility or network, such as a LAN or the Internet. The effect that the above factors may have on the estimated consumption rate estimated at block 330 may be stored in the data storage device 216 or on a server connected to a network in communication with the refueling planner 102 for future use.

The energy consumption estimator 226 may estimate energy consumption rate for each scheduled task of a mission to determine an overall consumption rate for the mission. In an example, the user may input the tasks to be performed by the work machine 110 and/or the user may input equipment, such as an implement including a plow, seeder, etc., that is being used in conjunction with the work machine. Such information from the user is provided to the refueling energy consumption estimator 226. In some examples, the work machine 110 is refueled after some tasks of the mission but before others. Therefore, based on the scheduled tasks for the mission, the energy consumption estimator 226 may estimate a consumption rate of the work machine 110 up until the work machine 110 reaches the potential refueling location and/or after the work machine 110 reaches the potential refueling location.

Using forestry as an example, tasks for the work machine 110 may include approaching a tree, moving a boom and harvest head to grasp the tree, sawing the tree, felling the tree, and moving or processing the tree by delimbing the tree stem while making cuts to the log. Each task above has a typical fuel usage that may be stored in the storage device 216. The energy consumption estimator 226 may then consult the scheduled tasks of the mission, retrieve the energy consumption information from the data storage device 216, and estimate the consumption rate of operation until reaching potential refueling locations during the mission. Furthermore, in forestry, the energy consumption estimator 226 may determine the consumption rate based on a first thinning, a second thinning, or a clear cutting of the forest. Additionally, ground-based cruising and/or aerial surveys may be used to determine the volume and type of timber and/or the particulars of the trees including the species, the average diameter, and/or the location such as by region, or precise location, which all may be factors for consumption rate estimation in forestry. More specifically, consumption rates for processing eucalyptus trees in Brazil may be different from processing pine and birch trees in Finland.

In some examples, at block 330, the energy consumption estimator 226 estimates the energy consumption rate based on a half-life of the work machine 110 or a half-life of individual components of the work machine 110. Sensors or malfunction detection systems may be used to identify defective parts or components, such as a deteriorated hydraulic pump, of the work machine 110 that affect fuel consumption. The declining health of a particular component of the work machine 110 may be detected by an unexpected increase in energy usage while performing a task with the component. Accordingly, historical records of the energy consumption rate for the work machine 110 may be stored in the data storage device and analyzed by the energy consumption estimator 226 to make the consumption rate estimate for the mission.

At block 330, the fuel consumption rate for the work machine 110 may be estimated based on conditions of the work area of the mission including crop yield, bulk soil density, soil moisture, grass height or density, mass of material being moved, etc. Using agriculture as an example, the work machine 110 may be used to harvest a corn field. The amount of energy consumed to harvest the field varies based on the amount of energy needed to move the work machine 110. In agriculture, the work machine 110 typically uses more energy in muddy conditions than in dry conditions. Furthermore, the amount of energy consumed varies based on the crop and material-other-than-grain (MOG) processed by the combine. In using the work machine 110 for tillage or planting, the amount of energy consumed may vary based on the soil type, soil bulk density, and soil moisture.

In the above examples, at block 330 of FIG. 3, the energy consumption estimator 226 may use site-specific information including, without limitation, a yield forecast map, a soil moisture map, or a soil compaction map. A priori estimates may be stored in the storage device 216 and can be updated using measured data from sensors on the work machine 110 or other devices in communication with the refueling planner 102. Such example sensors may include one or more of yield and mass flow sensors, soil moisture sensors, draft sensors, etc.

In FIG. 3, at block 340 the cost estimator 228 estimates the refueling costs for potential refueling locations based on the location and time that the work machine 110 and refueling machine 120 are expected to reach the potential refueling locations. Using the information calculated by the location analyzer 222, energy reserve estimator 224, and the energy consumption estimator 226, the cost estimator 228 estimates a fixed fueling cost, a variable fueling cost, and a downtime cost of refueling at the potential refueling locations. The process of block 340 is described in further detail with respect to FIG. 4, below.

Based on the costs estimated by the cost estimator 228 for refueling the work machine 110 at the potential locations at block 340, the location selector 230 selects a preferred refueling location at block 350 of FIG. 3. In the example, the location selector 230 may select the refueling location based on one or more factors, including minimum monetary costs, minimum time delay, minimum man-hours, etc. Default settings or predetermined settings for selecting the locations may be stored in the data storage device 216 and/or the user may select via the user interface 214 preferred settings for the location selector 230. The user may select, via the user interface 214, the preferred cost type that the location selector 230 is to use when selecting the refueling location. For example, the user may prefer to spend less time refueling and may be willing to spend more money. In such an example, the user instructs the location selector 230 via the user interface 214 to select the refueling location at block 350 based on shortest amount of time the user would spend refueling. As described above, the user may instruct the location selector 230 to select a location when refueling is desired.

Additionally or alternatively, in FIG. 3, once the energy reserve estimator 224 determines that a threshold amount of energy is remaining for the work machine 110, the refueling scheduler 220 may prompt the user via the user interface 214 at block 330 to provide selection criteria for the location selector 230 to select the refueling location. In some examples, when the energy reserve estimator 224 determines that the energy level has reached the threshold value, the location selector 230 may select from potential refueling locations and/or potential costs automatically generated by the refueling scheduler 220. The potential refueling locations and/or potential costs and display the selected location and/or potential locations to the user via the user interface 214. In some examples, the location selector 230 may consider secondary factors at block 350, such as a preferred fuel remaining after completion of the mission.

FIG. 4 is a flowchart of an example method 340, which may be executed to implement the process of block 340 of FIG. 3, for estimating costs of refueling a work machine at potential refueling locations. With reference to the preceding figures and associated descriptions, the process 340 of FIG. 4, upon execution, causes the cost estimator 228 to estimate costs of refueling the work machine 110 at potential refueling locations of work area.

At block 410, the cost estimator 228 identifies the refueling locations, such as the refueling locations 150, 160, retrieved and/or received by the refueling scheduler 220. As noted above, the refueling locations for one or more work area(s) may be stored in the data storage device 216 and/or received from the user via the user interface 214.

At block 420 of FIG. 4, the cost estimator 228 estimates the fixed fueling costs for the potential refueling locations based on costs of labor and costs of the work machine 110 being stopped. For example, the fixed costs may be based on the labor and/or rental costs of the work machine 110 for the period of time that it takes to refuel the work machine 110. The labor and rental cost for the period of time may include costs of shutting down the work machine 110, opening the fuel cap, replacing the fuel cap, restarting the work machine 110, etc. and any corresponding costs that may be associated with that amount of time charged by the refueling service. In other words, the fixed costs include costs that are generally the same each time the work machine 110 is refueled. In some examples, the fixed costs may be adjusted, for example, via the user interface 214, based on an hourly billing rate for an individual operating the work machine 110.

In the example of FIG. 4, at block 430, the cost estimator 228 estimates the variable fueling cost based on the costs of labor and costs of the work machine 110 being stopped proportional to how much fuel is added to the work machine 110. Accordingly, the cost estimator 228 uses the distance and/or time information from the location analyzer 222, the estimated energy remaining from the energy reserve estimator 224, and/or the estimated consumption rate from the energy consumption estimator 226 to determine the variable fueling cost. Using the distance and/or time information, the energy remaining, and the energy consumption rate, the cost estimator 226 may calculate the amount of fuel that will be needed to refuel the work machine 110 when the work machine 110 reaches the corresponding refueling location. At block 430, the cost estimator 228 may determine the refueling rate, such as 5 gallons per minute, of the refueling machine 120. The cost estimator 228 may retrieve this information from the data storage device 216, an input from the user 214, from the operator of the refueling machine 120, and/or from a network in communication with the refueling planner 102. Based on the rate of refueling and the amount of fuel that will be added to the fuel tank of the work machine 110 by the refueling machine 120, the cost estimator can determine the amount of time that it will take to refuel the work machine 110.

The cost estimator 228, at block 430, may determine the amount of fuel needed based on an input from the user. The user may not wish to completely “fill-up” the work machine 110 for corresponding refueling locations in order to leave less fuel in the tank upon completion of a task or mission. Accordingly, a user may be prompted via the user interface 214 to indicate the amount of fuel that will be received at the corresponding refueling locations and the cost estimator estimates the variable costs based on the user-identified amount.

In one example, a user may indicate via the user interface 214 that a low amount of fuel is desired upon completion of the task. Such an example may occur when the work machine 110 is to be transported from the work area following completion of the task and a minimal weight of the work machine 110 is desired. Accordingly, the cost estimator 228 may estimate a task completion estimate equivalent to the amount of fuel required to complete the task following refueling at the corresponding location. In such an example, the cost estimator 228 may use the distance remaining along a work path determined by the location analyzer 222 and the energy consumption rate determined by the energy consumption estimator 226 to estimate the desired amount of fuel for the corresponding fuel type. The work machine 110 may then complete the task and have a low volume of fuel remaining in its reserve.

At block 440 of FIG. 4, the cost estimator 228 estimates downtime costs of refueling the work machine 110 at the potential refueling locations. In the illustrated example, to estimate the downtime costs, the cost estimator 228 determines a probability that the work machine 110 may run out of fuel, a cost per unit time of the work machine 110 being out of use, such as per hour, and/or a duration that the work machine 110 is out of fuel to determine the downtime costs for each of the potential refueling locations. The above probability may be used to capture error in the estimated energy reserves, consumption rate, and the ability of the refueling machine 120 to meet at the refueling location at the corresponding time. The cost estimator 228 bases the probability distribution of downtime of the work machine 110 on one or more factors, including without limitation: accuracy of estimated energy in the fuel tank of the work machine 110 including accuracy of the fuel level, accuracy of the energy content of the fuel, fuel factor accuracy, etc.; accuracy of consumption rate to complete the tasks at the worksite including task energy needs, efficiency of the work machine 110 due to component health and/or malfunction, operator efficiency, etc.; variability of time of arrival for the refueling machine 120 based on traffic conditions and/or road conditions at the estimate time for refueling; and variability in scheduling windows for the refueling machine 120, for example, due to completing refueling services for another customer before meeting the work machine 110 at the refueling location. The cost estimator 228 may receive information for the above factors from the work machine 110, the refueling machine 120, the user via the user interface 214, or a network in communication with the refueling planner 102.

In FIG. 4, the calculated downtime costs at block 440 account for potential losses incurred by a user of the work machine 110 due to the work machine 110 being out of use for an estimated period of time based on the probability distribution above. The downtime cost per unit time may be based on the labor, rental costs, ownership costs, opportunity costs, etc. for the work machine 110 being unusable per unit of time. The downtime costs may include costs of other work machines dependent upon the work machine 110. For example, if an excavator runs out of fuel, the excavator and a dump truck transporting dirt from the excavator both affect downtime costs because the dump truck may not have dirt to transport. In the illustrated example, the cost estimator 228 estimates the amount of time that the work machine 110 might be out of use based on the energy reserve, expected arrival of the refueling machine 120, the probability that the work machine runs out of fuel, and/or the probability that the refueling machine 120 arrives at the corresponding time.

At block 450 of FIG. 4, the cost estimator 228 uses the fixed fueling costs, the variable fueling costs, and/or the downtime costs to determine refueling costs for each of the potential refueling locations. The fixed fueling costs, variable costs, and downtime costs may be summed. In some examples, more weight is given to one cost over another. For example, 50% of cost calculation is based on downtime costs, and 50% of the cost calculation is based on the fixed costs and variable costs. The calculated refueling costs may then be ranked based on various costs including monetary costs, labor costs, time delay, or other similar costs by the cost estimator 228 and are used by the location selector 230 and/or the user to select a preferred refueling location.

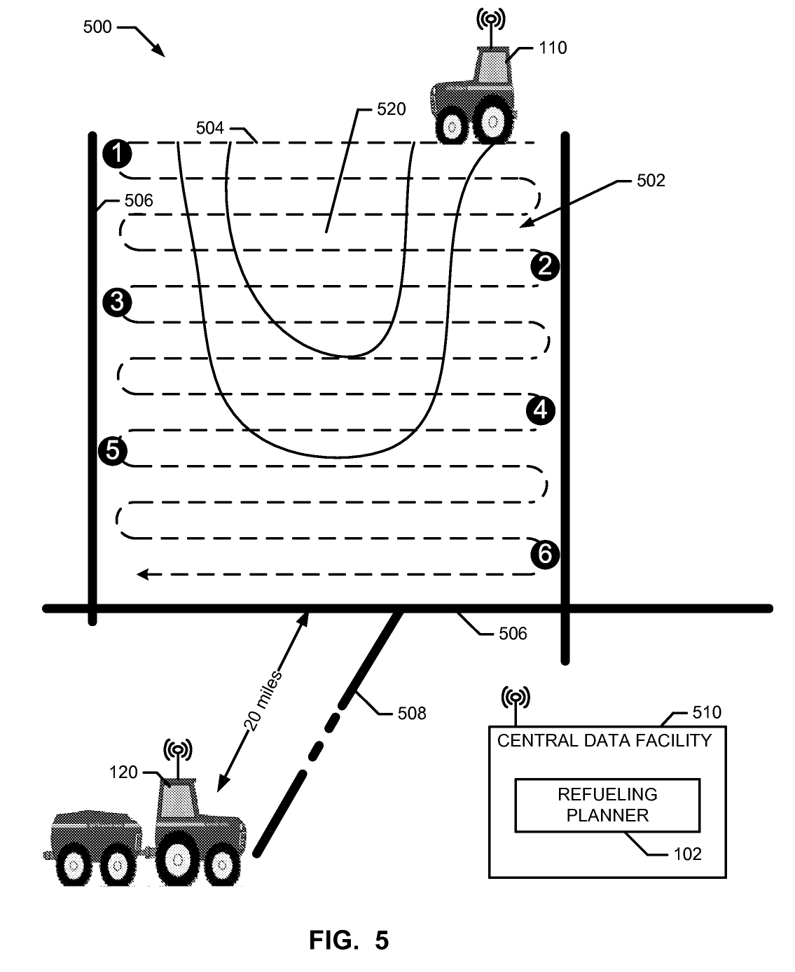

FIG. 5 illustrates an example environment of use 500 for using the refueling planner 102 of FIG. 2. In the illustrated example, the work machine 110 and refueling machine 120 use the refueling planner 102 to scheduling refueling of the work machine 110. The environment 500 includes a work area 502 with a work path 504, access roads 506, highway 508, and central data facility 510. The work area 502 includes a ridge 520 represented by contour lines of the work area 502. In the illustrated example of FIG. 5, the refueling planner 102, which may be used to implement the refueling planner of FIGS. 1 and/or 2, is located at the central data facility 510, though it may be located in the work machine 110 or a user device such as a mobile phone, smartphone, tablet computer, personal computer, PDA, etc. In FIG. 5, a wireless network is used to facilitate wireless communication between the central data facility 510, the work machine 110, the refueling machine 120, and/or devices associated with the work machine 110 and/or refueling machine 120.

For the illustrated example of FIG. 5, assume that at 12:00 PM a refueling service indicates to a user of the work machine 110 that the refueling machine 120 will be available for refueling between 4:00 PM and 6:00 PM in the evening and will be located approximately 20 miles from the user's work area. At 12:00 PM, the user may instruct the refueling planner 102 to determine a number of refueling locations 1-6 for refueling the work machine 110 between 4:00 PM and 6:00 PM. The user may provide the refueling locations to the refueling planner 102 and/or the refueling planner 102 may have the potential refueling locations stored in a data storage device, such as the data storage device 216. In other examples, the refueling planner 102 may generate the refueling locations based on the work path 504 and the access roads 506 surrounding the work area 502. The location analyzer 222 of the refueling planner may then identify locations where the work machine 110 will be near an access road 506 that is accessible to the refueling machine 120.

In FIG. 5, the refueling planner 102 then determines the energy reserve and consumption rate of the work machine 110. The refueling planner 102 retrieves the fuel level and fuel factor information from the work machine 110 via the wireless network and calculates the energy reserve at 12:00 PM. The refueling planner 102 then retrieves a task schedule for the times between 12:00 PM and 6:00 PM from the user, from the work machine 110, and/or from the central data facility. In FIG. 5, the work machine is to harvest crops in the work area 502 for the duration of time, though other tasks may be performed during that time period. The refueling planner 102 may also retrieve expected crop yield, soil conditions, topographical information, etc. for the work area 502. Based on one or more of the above factors, the refueling planner 102 estimates a consumption rate for the work machine between 12:00 PM and 6:00 PM. For example, topographical information may reveal that a ridge is laterally located between the refueling location 1 and refueling location 2. Accordingly, the energy consumption rate of the work machine 110 is likely greater between refueling locations 1 and 2 due to the ridge 520 than between refueling locations 5 and 6 where the work area 502 is generally flat. Additionally, the refueling planner 102 can project a time of arrival at the refueling locations 1-6 based on the topography. For example, it may take longer for the work machine 110 to get from location 2 to location 3 than from location 4 to location 5 due to the ridge 520 between location 2 and location 3.

In some examples, the refueling planner 102 may determine that estimated crop yield is greater between locations 5 and 6, which may increase the fuel consumption rate but may not affect operating time between locations 5 and 6. The refueling planner 102 may alternatively or additionally receive the crop yield information from the user via the user interface 214, from historical data stored in the data storage device 216, and/or from forecast information retrieved from a network, such as the Internet, in communication with the refueling planner 102. The refueling planner 102 may additionally or alternatively receive soil conditions based on moisture, soil type, compaction, etc. from the user via the user interface 214, historical data stored in the data storage device 216, and/or a network in communication with the refueling planner 102.

In FIG. 5, the refueling planner 102 requests refueling schedules for the refueling machine 120. Additionally, the refueling planner 102 determines expected traffic conditions perhaps from the Internet, a GPS service, historical data, etc. for the expected time frame of 4:00 PM to 6:00 PM. For example, downtime costs for refueling at 5:30 PM may be greater than downtime costs for refueling at 4:30 PM based on projected rush hour traffic conditions on the highway 508, which may be stored in the data storage device 216.

Accordingly, in the illustrated example of FIG. 5, based on the above information, the refueling planner 102 calculates fixed costs, variable costs, and downtime costs for the refueling locations 1-6 as described herein with respect to FIGS. 2-4.

In FIG. 5, the refueling planner 102 may monitor or project refueling costs for a specific time period, such as a season, a month, etc. For example, if an operator estimates that it will take approximately one month to complete a mission for the work area 502, the refueling planner 102 may be used to project costs for the month of refueling the work machine 110 using the refueling machine 120. The refueling planner 102 may determine the preferred refueling amount for each time that the work machine 110 is to be refueled based on the fixed, variable, and downtime costs calculated above. In such examples, a refueling cost curve may be monitored and/or estimated for refueling the work machine 110.

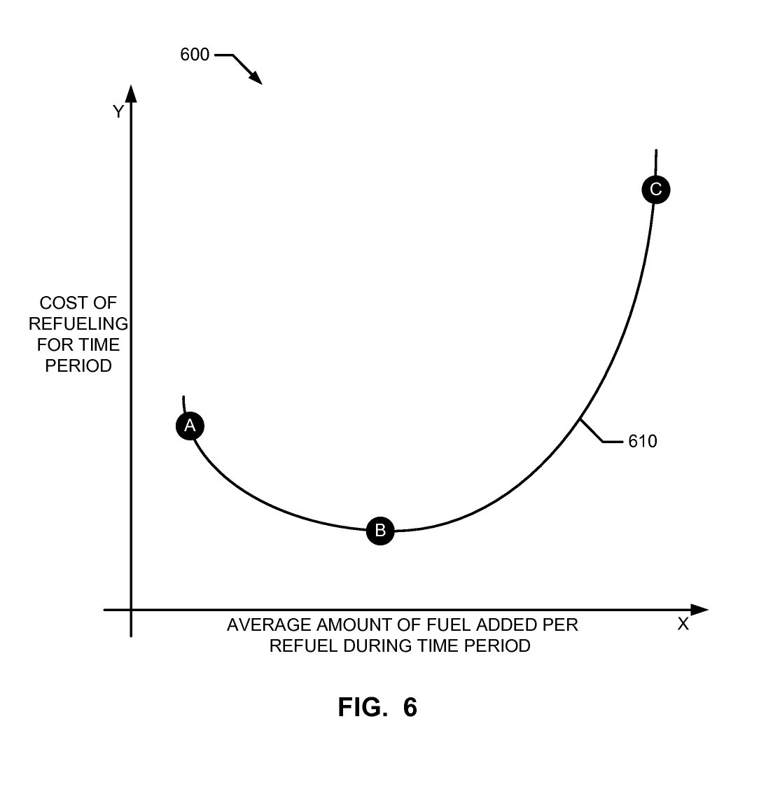

FIG. 6 is a graph 600 representing cost estimates for the refueling planner of FIGS. 1 and/or 2 for refueling a work machine over a period of time based on an average amount of fuel added per refuel. The example graph 600 presents a refueling cost curve 610 representative of refueling the work machine 110 over a given time period, such as a week, a month, a season, etc. The Y-axis of the graph 600 represents the cost of refueling the work machine 110 for the time period. The X-axis of the graph 600 represents the average amount of fuel added per refuel to the work machine 110 during the time period. The refueling cost curve 610 includes three points A, B, and C.

In FIG. 6, at point A, the average amount of fuel to be added is minimal. Such an example of this scenario would be when an operator frequently “tops off” the work machine 110. At point A, costs may be higher than a preferred minimal cost because of the frequency of refueling. The more times that the work machine 110 needs to be refueled, the greater the amount of fixed costs included in the refueling cost, however, the probability of running out of fuel, and thus the impact of downtime costs, are lowered.

Between points A and B of FIG. 6, greater amounts of fuel are added to the work machine 110 on average. Therefore, the fixed costs as a portion of total refueling cost decreases, and the probability of running out of fuel generally remains low until point B is reached on the cost curve. At point B of the refueling cost curve 610 a preferred average amount of fuel to add during refueling that keeps the costs at a minimum for the given time period is identified.

Between points B and C on the cost curve 610, the probability of running out of fuel at least once over the course of the season increases as the amount of fuel that is added to the work machine 110 increases because a higher average amount of fuel indicates that the work machine 110 is traveling a further distance and/or operating for longer amounts of time between scheduled refuels than if a lower amount of fuel is added to the work machine on average, i.e., the work machine 110 is refueled more frequently. At point C of FIG. 6, the maximum average amount of fuel leads to greater costs because of the probability of downtime. If an operator averages completely having to refill an empty fuel tank of the work machine 110 on each refuel, costs of downtime drastically increase the cost of refueling for the time period in the illustrated example. The cost curve 610 may vary over time based on a completion-or-penalty cost due to missing deadlines of completing the mission for the work area. These completion penalties may be included in the downtime costs, thus affecting the overall refueling cost curve 610, including the location of point B.

FIG. 7 is a block diagram of an example processor platform 700 capable of executing the instructions to execute the methods of FIGS. 3 and/or 4 to implement the refueling planner 102 of FIGS. 1, 2, and/or 5. The processor platform 700 can be, for example, a server, a personal computer, a mobile phone such as a cell phone, a personal digital assistant (PDA), an Internet appliance, or any other type of computing device.

The processor platform 700 of the instant example includes a processor 712. For example, the processor 712 can be implemented by one or more microprocessors or controllers from any desired family or manufacturer.

The processor 712 includes a local memory 713, such as a cache, and is in communication with a main memory including a volatile memory 714 and a non-volatile memory 716 via a bus 718. The volatile memory 714 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 716 may be implemented by flash memory and/or any other desired type of memory device. Access to the main memory 714, 716 is controlled by a memory controller.

The processor platform 700 also includes an interface circuit 720. The interface circuit 720 may be implemented by any type of interface standard, such as an Ethernet interface, a universal serial bus (USB), and/or a PCI express interface.

One or more input devices 722 are connected to the interface circuit 720. The input device(s) 722 permit a user to enter data and commands into the processor 712. The input device(s) 722 can be implemented by, for example, a keyboard, a mouse, a touchscreen, a track-pad, a trackball, isopoint and/or a voice recognition system. The input device(s) may be used to implement the user interface 214 of FIG. 2.

One or more output device(s) 724 are also connected to the interface circuit 720. The output device(s) 724 can be implemented, for example, by display devices such as a liquid crystal display, a cathode ray tube display (CRT), a printer and/or speakers. The interface circuit 720, thus, typically includes a graphics driver card. The output device(s) 724 may be used to implement the user interface 214 of FIG. 2.

The interface circuit 720 also includes a communication device such as a modem or network interface card to facilitate exchange of data with external computers via a network 726, such as an Ethernet connection, a digital subscriber line (DSL), a telephone line, coaxial cable, a cellular telephone system, etc.

The processor platform 700 also includes one or more mass storage devices 728 for storing software and data. Examples of such mass storage devices 728 include floppy disk drives, hard drive disks, compact disk drives and digital versatile disk (DVD) drives.

The processes of FIGS. 3 and/or 4 may be stored in the mass storage device 728, in the volatile memory 714, in the non-volatile memory 716, and/or on a removable storage medium such as a CD or DVD. The mass storage device 728, the volatile memory 714, the non-volatile memory 716, and/or a removable storage medium such as a CD or DVD disc may be used to implement the data storage device 216 of FIG. 2.

From the foregoing, it will appreciate that the above disclosed methods, apparatus and articles of manufacture provide a method and apparatus scheduling refueling locations and times for a work machine and a refueling machine based costs associated with refueling at the corresponding times and locations, as described herein.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

1. A method to schedule refueling of a vehicle, the method comprising:
determining a plurality of potential costs of refueling a work machine at a plurality of locations based at least in part on a location of the work machine, a location of a refueling machine, an energy reserve of the work machine, and an energy consumption rate of the work machine to perform one or more tasks of a mission, the energy consumption rate being based at least in part on one or more task parameters; and
selecting a refueling location from the plurality of locations based at least in part on the plurality of potential costs.

2. A method according to claim 1, wherein the one or more tasks are to be performed in a work area and the selected refueling location is located at the work area or proximate to the work area.

3. A method according to claim 1, wherein the selected refueling location corresponds to a preferred cost comprising at least one of an estimated minimum monetary cost or an estimated minimum time delay.

4. A method according to claim 1, wherein determining the plurality of potential costs further comprises calculating the plurality of potential costs based at least in part on a monetary cost of refueling the work machine.

5. A method according to claim 4, wherein the monetary cost of refueling the work machine is based at least in part on a fixed fuel cost, a variable fueling cost, and a downtime cost.

6. A method according to claim 5, wherein the downtime cost is calculated based at least in part on a probability that the work machine runs out of fuel, a cost per unit time of the work machine being down, and an estimated amount of time that the work machine is down.

7. A method according to claim 1, wherein the one or more task parameters comprise at least one of crop yield, soil bulk density, soil moisture, vegetation height, vegetation density, or load of the work machine.

8. A method according to claim 1, wherein the energy consumption rate for the work machine is determined by estimating effects of the one or more task parameters on the energy consumption rate based on at least one of a yield forecast map, a soil moisture map, or a soil compaction map.

9. A method according to claim 1, further comprising determining the plurality of potential costs of refueling based at least in part on a work path for completing the mission.

10. A method according to claim 1, further comprising prompting a user to indicate whether to select the cost based on at least one of a minimum monetary cost, a minimum delay time, or a minimum amount of labor.

11. A method according to claim 1, further comprising displaying at least one of the corresponding time or the corresponding location of the selected refueling location on a user interface of at least one of the work machine or the refueling machine.

12. A method according to claim 1, further comprising alerting at least one of an operator of the work machine or an operator of the refueling machine when a corresponding time for refueling at the selected location is within a threshold period of time.

13. A method according to claim 1, wherein determining the plurality of potential costs further comprises estimating an amount of fuel for refueling the work machine at the plurality of locations to complete the mission.

14. An apparatus to schedule refueling, the apparatus comprising:
a cost estimator to determine a plurality of potential costs of refueling a work machine at a plurality of locations based at least in part on a location of the work machine, a location of a refueling machine, an energy reserve of the work machine, and an energy consumption rate of the work machine, the energy consumption rate being based at least in part on one or more task parameters; and
a location selector to select a refueling location from the plurality of refueling locations based on the plurality of potential costs.

15. An apparatus according to claim 14, wherein the one or more tasks are to be performed in a work area and the selected refueling location is located at the work area or proximate the work area.

16. An apparatus according to claim 14, wherein the selected refueling location corresponds to a preferred cost comprising at least one of an estimated minimum monetary cost or an estimated minimum time delay.

17. An apparatus according to claim 14, wherein the cost estimator is further to calculate the plurality of potential costs based at least in part on a monetary cost of refueling the work machine.

18. An apparatus according to claim 17, wherein the monetary cost of refueling the work machine is based at least in part on a fixed fuel cost, a variable fuel cost, and a downtime cost.

19. An apparatus according to claim 18, wherein the downtime cost is calculated based on a probability that the work machine runs out of fuel, a cost per unit time of the work machine being out of use, and an estimated amount of time that the work machine is out of use.

20. An apparatus according to claim 14, wherein the one or more task parameters comprise at least one of crop yield, bulk soil density, soil moisture, vegetation height, vegetation density, or load of the work machine.

21. An apparatus according to claim 14, wherein the energy consumption rate for the work machine is determined by estimating effects of the one or more task parameters on the energy consumption rate based on at least one of a yield forecast map, a soil moisture map, or a soil compaction map.

22. An apparatus according to claim 14, wherein the plurality of potential costs of refueling are based at least in part on a work path for completing the mission.

23. An apparatus according to claim 14, further comprising a user interface to prompt a user to indicate whether to select the cost based on at least one of a minimum monetary cost, a minimum delay time, or a minimum amount of labor cost.

24. An apparatus according to claim 14, a user interface to display at least one of the corresponding time or the corresponding location of the selected refueling location.

25. An apparatus according to claim 14, further comprising a user interface to prompt at least one of an operator of the work machine or an operator of the refueling machine when a corresponding time for refueling at the selected location is within a threshold period of time.

26. An apparatus according to claim 14, wherein the cost estimator is to estimate an amount of fuel for refueling at the plurality of locations to complete the mission after refueling at corresponding ones of the plurality of locations.

27. A tangible machine readable storage medium comprising instructions which when executed cause a machine to at least:
determine a plurality of potential costs of refueling a work machine at a plurality of locations based at least in part on a location of the work machine, a location of a refueling machine, an energy reserve of the work machine, and an energy consumption rate of the work machine to perform one or more tasks of a mission, the energy consumption rate being based at least in part on one or more task parameters; and
select a refueling location from the plurality of locations based on the plurality of potential costs.

28. A storage medium according to claim 27, wherein the instructions, when executed, further cause the machine to estimate an amount of fuel for refueling at the plurality of locations to complete the mission after refueling at corresponding ones of the plurality of locations.
